(19) United States
(12) Patent Application Publication
(10) Pub. No.: US 2026/0076291 A1
(43) Pub. Date: Mar. 19, 2026

(54) MATERIAL SPREADER FLOW RATE CONTROL SYSTEM AND METHOD

(71) Applicant: George A. Palmer, LTC, Charles Walters Equipment, New Lenox, IL (US)

(72) Inventors: Bob Petrungaro, New Lenox, IL (US); Michael Palmer, Peckleton (GB); Marcus Palmer, Peckleton (GB)

(21) Appl. No.: 19/332,192

(22) Filed: Sep. 18, 2025

Related U.S. Application Data
(60) Provisional application No. 63/695,995, filed on Sep. 18, 2024.

(51) Int. Cl. A01C 17/00; A01C 15/00

(52) U.S. Cl. CPC A01C 17/008; A01C 15/006

(57) ABSTRACT

A material spreader includes a hopper, a valve, a lever, and a stop. The valve obstructs flow of a material from the hopper in a closed position, and passes the material from the hopper in an opened position. The lever is operatively connected to the valve, and pivotally or slidingly fixed relative to the valve. Pivoting or sliding the lever in a first direction actuates the valve toward the opened position. Pivoting or sliding the lever in a second direction actuates the valve toward the closed position. Pressing the lever inward in the longitudinal direction drives the lever from an extended position toward a retracted position. The stop obstructs the lever from traveling passed a predetermined location in the second direction when the lever is in the extended position. The lever passes the predetermined location in the second direction when the lever is in the retracted position.

### CROSS REFERENCE TO RELATED APPLICATIONS

This application claims priority to and the benefit of U.S. Provisional Application No. 63/695,995 filed on Sep. 18, 2024, entitled “RATE CONTROL FOR LAWN SPREADER,” the entirety of which is incorporated herein by reference.

### BACKGROUND

A lawn spreader is a tool designed to hold and evenly distribute materials such as fertilizer, grass seed, lime, sand, ice melt/salt, or herbicide from a hopper over a lawn or garden area. Some lawn spreader may generally resemble a wheel barrow and may be configured to be pushed by a user across a desired area while distributing materials from the hopper. Other lawn spreaders may be hand-held. Generally, lawn spreaders may help ensure that the materials held in the hopper are applied uniformly to a surrounding area, for example, to promote healthy lawn growth and prevent patchy or uneven coverage of the materials. Using a lawn spreader can help save time and ensure more consistent results compared to manual spreading.

Common lawn spreader types include broadcast or rotary spreaders, which use a spinning disk to fling material outward in a wide, circular pattern that covers a broad area quickly. Drop spreaders release material directly beneath the spreader in a narrow, controlled path, which enables more precise application suited for smaller lawns or targeted areas. Lawn spreaders used in golf, sportsground, and landscaping applications typically include one of two on/off gauge systems.

Common lawn spreader types often incorporate a sliding lock gauge system that uses a hand-adjusted sliding lock mechanism and a lever attached to a control rod. The lever and control rod couple to a shutter on the underside of the hopper, which controls the size of an opening in the hopper. A gauge scale located on the handlebars actuates the lever to set the size of the opening. This assembly provides two functions: setting or locking the opening to a desired size, and moving the shutter backwards and forwards to open and close the opening. The assembly is powered entirely by hand movement without spring assistance. Closing the shutter requires the same time, movement, and effort as opening the shutter, and the user must perform both actions manually while simultaneously setting the shutter position.

Common lawn spreader types often incorporate a spring-assisted gauge system that uses an on/off gauge assembly with a spring-assisted snap-shut action for the opening. In this system, the setting of the opening is separate from the handlebar-located gauge assembly. The opening size is typically adjusted at the hopper using a slider lock that travels along a bar or a rotating dial, either of which can be locked in a selected position. This setting only determines the size of the opening when the gauge assembly turns the system on, but does not itself open or close the opening. The handlebar-mounted gauge assembly functions only as an on/off control. As a result, the user must operate two different mechanisms: the hopper-mounted adjustment for aperture size, and the handlebar control for opening and closing. Conventional spreaders of this type demand greater coordination from the user, and misoperation often results in mishaps such as over-application or spillage when material flows unexpectedly.

### BRIEF DESCRIPTION

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure. Any of the described aspects may be isolated or combined with other described aspects without limitation to the same effect as if they had been described separately and in every possible combination explicitly.

Disclosed is a material spreader including a flow rate control system and mechanism for distributing material, and more particularly a spring-assisted flow rate control system that provides a combined aperture setting function and on/off function. The flow rate control system integrates an aperture setting, an on/off functionality, and a spring that biases a valve toward a closed position. The flow rate control system forms a triple function gauge assembly located in a single mechanism of the material spreader.

The flow rate control system of the material spreader includes a lever, a stop, a protuberance, and a spring. The lever operates in a first direction to actuate the valve toward an opened position, in a second direction to actuate the valve toward a closed position, and in a longitudinal direction between an extended position and a retracted position. The stop includes a sliding element that locks the lever at a predetermined location corresponding to a desired aperture size of the hopper. The aperture size directly determines the amount of material released from the hopper during use of the material spreader.

The lever includes a first arm, a second arm, and a grip. The spring biases the second arm away from the first arm in the longitudinal direction toward the extended position. The lever travels in the first direction and the second direction relative to the hopper while the spring applies force in the longitudinal direction. The protuberance extended from the lever presses against a recess of the stop, and the recess corresponds to the predetermined location selected by a user. The recess locks the lever in place to maintain the hopper aperture at the preset rate through a rod that operatively connects the lever to a valve disposed on an underside of the hopper.

A second spring applies a pull-to-shut force on the rod to bias the valve toward the closed position whenever the valve is open to any degree. The protuberance of the lever remains locked in the recess of the stop to hold the valve in the open position until the user pushes the lever inward in the longitudinal direction. This inward motion drives the protuberance out of the recess, releases the lever from the stop, and allows the spring to snap the lever and the rod toward the closed position, resulting in a fast snap-shut action of the valve on the underside of the hopper.

According to one aspect, a material spreader includes a hopper that defines an aperture and a valve fixed with the hopper. The valve obstructs flow of a material through the aperture in a closed position and passes the material through the aperture in an opened position. A lever is operatively connected to the valve and is pivotally or slidingly fixed relative to the valve. Pivoting or sliding the lever in a first direction actuates the valve toward the opened position, and pivoting or sliding the lever in a second direction actuates the valve toward the closed position. Pressing the lever inward in a longitudinal direction drives the lever from an extended position toward a retracted position, the longitudinal direction being orthogonal to the first direction and the second direction. A stop obstructs the lever from traveling passed a predetermined location in the second direction when the lever is in the extended position, and the lever passes the predetermined location in the second direction when in the retracted position.

According to another aspect, a flow rate control system includes a valve that obstructs flow of a material in a closed position and passes the material in an opened position. A lever is operatively connected to the valve and is pivotally or slidingly fixed relative to the valve. Pivoting or sliding the lever in a first direction actuates the valve toward the opened position, and pivoting or sliding the lever in a second direction actuates the valve toward the closed position. Pressing the lever inward in a longitudinal direction drives the lever from an extended position toward a retracted position, the longitudinal direction being orthogonal to the first direction and the second direction. A stop obstructs the lever from traveling passed a predetermined location in the second direction when the lever is in the extended position, and the lever passes the predetermined location in the second direction when in the retracted position.

The innovation described herein provides a material spreader that offers reliable and efficient control of material dispersal from a hopper. In addition to other described features, functions, and benefits, the flow rate control system integrates aperture setting, on/off control, and spring-assisted snap-shut functionality in a single mechanism where a lever, stop, and protuberance arrangement enables precise aperture adjustment while maintaining fast closure through spring bias when the lever is pressed inward.

### BRIEF DESCRIPTION OF THE DRAWINGS

FIG. 1 is a perspective view of an example material spreader including a flow rate control system in accordance with aspects of the innovation.

FIG. 2 is a front view of the material spreader of FIG. 1.

FIG. 3 is a first side view of the material spreader of FIG. 1.

FIG. 4 is a second side view of the material spreader of FIG. 1.

FIG. 5 is a back view of the material spreader of FIG. 1.

FIG. 6 is a top view of the material spreader of FIG. 1.

FIG. 7 is a bottom view of the material spreader of FIG. 1.

FIG. 8 is an enlarged, partial perspective view of an example material spreader in accordance with aspects of the innovation, with a lever in a first position.

FIG. 9 is an enlarged, partial perspective view of the material spreader of FIG. 8, with the lever in a second position.

FIG. 10 is a partly assembled side view of a flow rate control system included in the material spreader of FIG. 8.

FIG. 11 is a side view of a first arm included in the flow rate control system of FIG. 10.

FIG. 12 is a side view of a second arm included in the flow rate control system of FIG. 10.

FIG. 13 is a front view of the second arm of FIG. 12.

FIG. 14 is a side view of a lever including the first arm of FIG. 11 and the second arm of FIG. 12.

FIG. 15 is a partial top perspective view of the flow rate control system of FIG. 10.

FIG. 16 is a partial side perspective view of the flow rate control system of FIG. 10.

FIG. 17 is a partial side perspective view of the flow rate control system of FIG. 10 mounted on a frame included in the material spreader of FIG. 8, with the lever of FIG. 14 in a first position.

FIG. 18 is a partial side perspective view of the flow rate control system of FIG. 10 mounted on the frame of FIG. 17, with the lever of FIG. 14 in a second position.

FIG. 19 is a side perspective view of the flow rate control system of FIG. 10, including paneling that forms a housing.

FIG. 20 is a bottom perspective view of the flow rate control system of FIG. 10.

FIG. 21 is a flow chart of an embodiment of a method of setting a flow rate control system for a lawn spreader in accordance with aspects disclosed herein.

FIG. 22 is a flow chart of an embodiment of a method of closing a flow rate control system for a lawn spreader in accordance with aspects disclosed herein.

### DETAILED DESCRIPTION

Reference will now be made in detail to exemplary embodiments of the present teachings, examples of which are illustrated in the accompanying drawings, where like numbered aspects refer to a common feature throughout. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings.

In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more”unless context suggest otherwise.

Further, unless context suggest otherwise, descriptions of shapes (e.g., circular, rectangular, triangular, etc.) refer to shapes meeting the definition of such shapes and general representation of such shapes. For instance, a triangular shape or generally triangular shape may include a shape that has three sides and three vertices or a shape that generally represents a triangle, such as a shape having three major sides that may or may not have straight edges, triangular like shapes with rounded vertices, etc.

Further, the term “in” as used to describe an object with respect to a given direction (e.g., an edge extended in a left-right direction) is intended to denote an orientation that is substantially parallel to the specified direction. In contrast, the term “along” as used to describe an object with respect to a given direction (e.g., an edge extended along a vertical direction) is intended to indicate that a feature or element possesses a common vector component in that direction, even if its overall alignment is not strictly parallel.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited thereto.

Disclosed is a rate control assembly and mechanism for a lawn spreader and, more particularly, a spring-assisted rate control assembly and mechanism that provides a combined aperture setting and on/off function for a lawn spreader. In an embodiment, the lawn spreader and flow rate control system and assembly combines the aperture setting, the on/off functionality, and a spring to close action. In an embodiment, the lawn spreader and flow rate control system and assembly includes a triple function gauge assembly. In an embodiment, the lawn spreader and flow rate control system and assembly includes these three functionalities in one or more (or all) of a single location, unit, or mechanism of the lawn spreader.

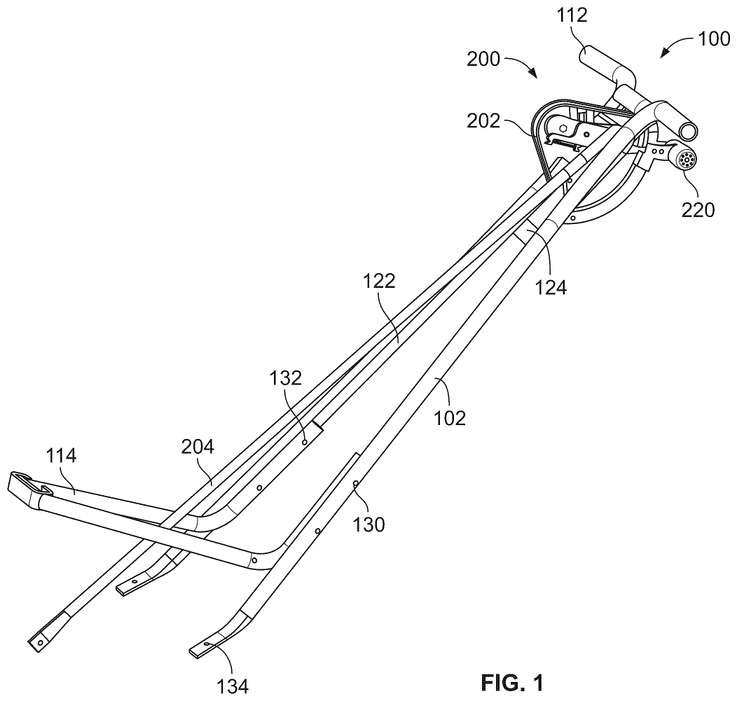

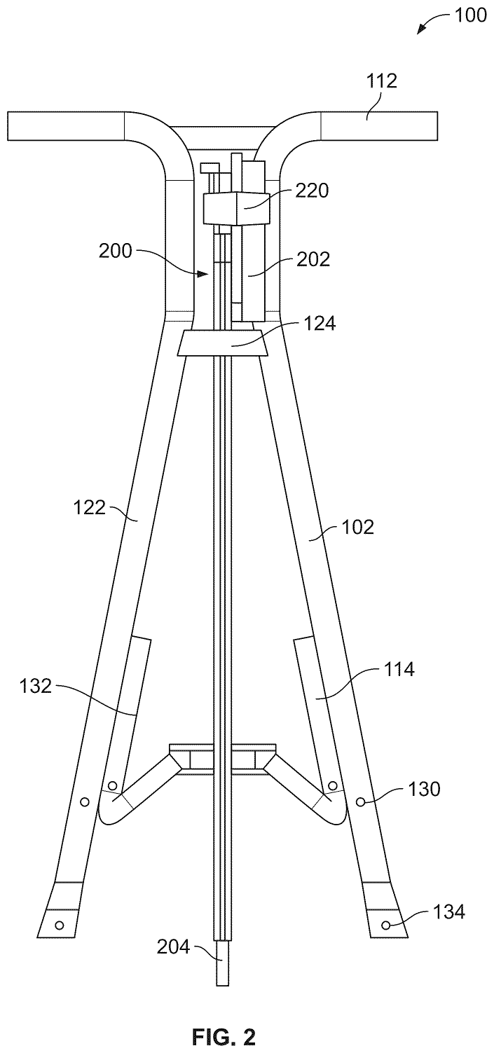

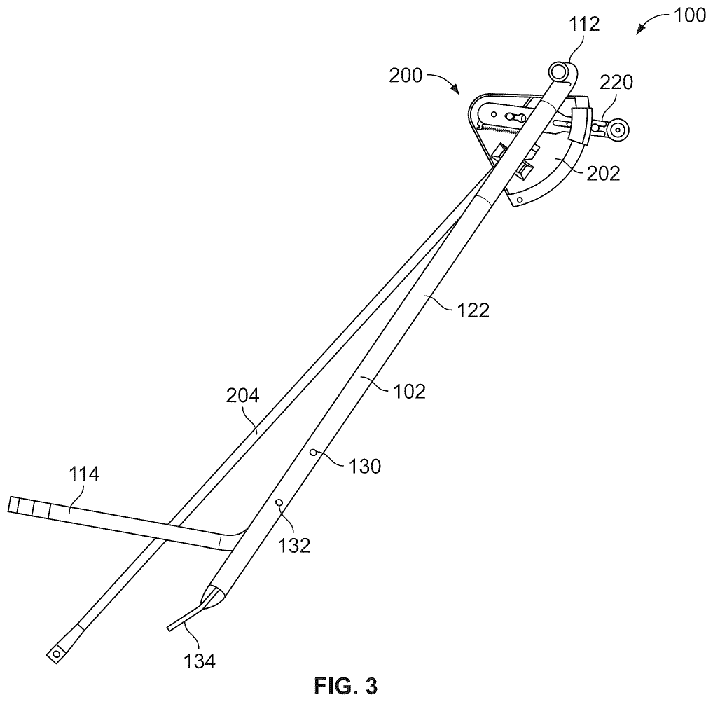

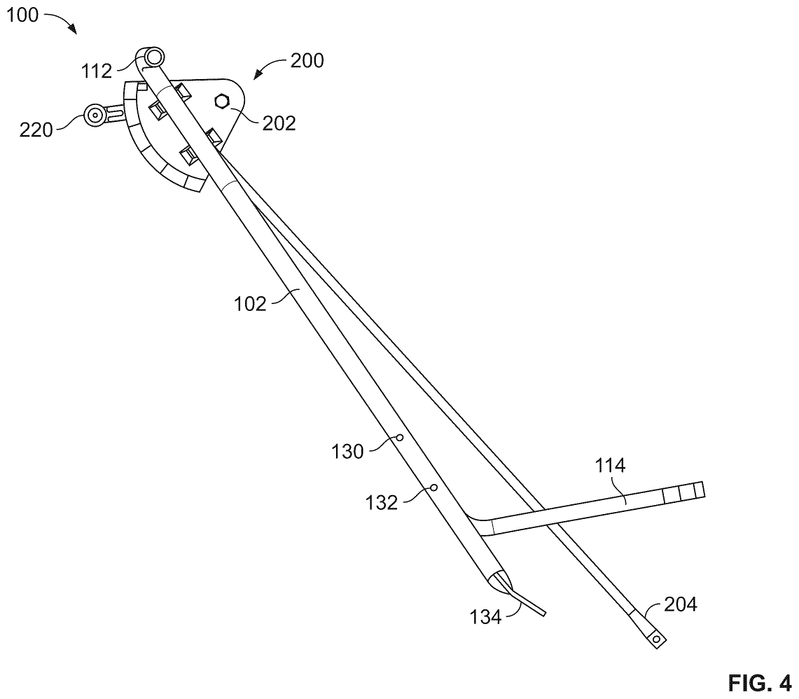

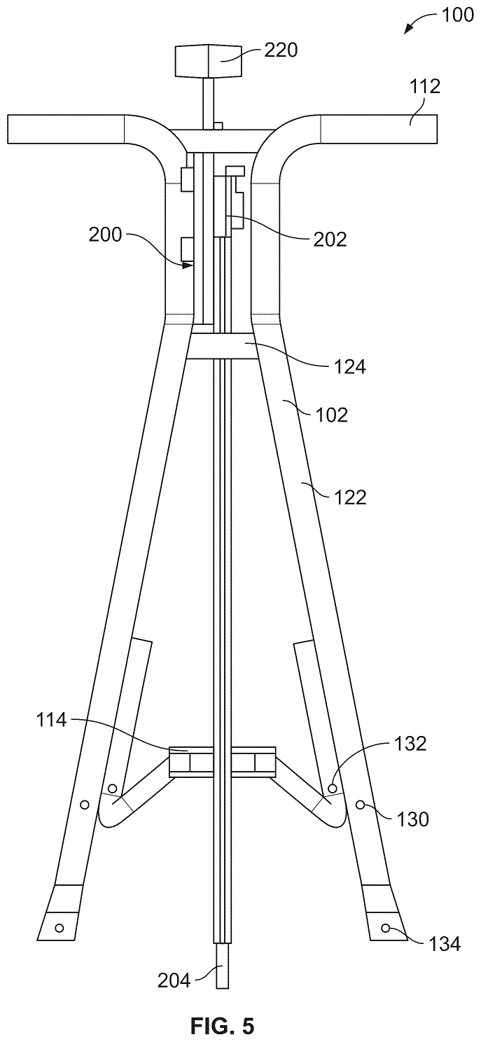

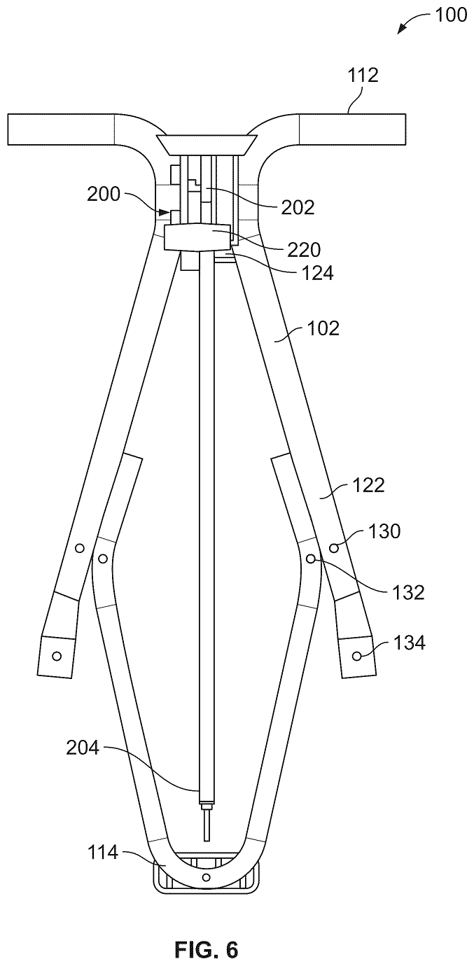

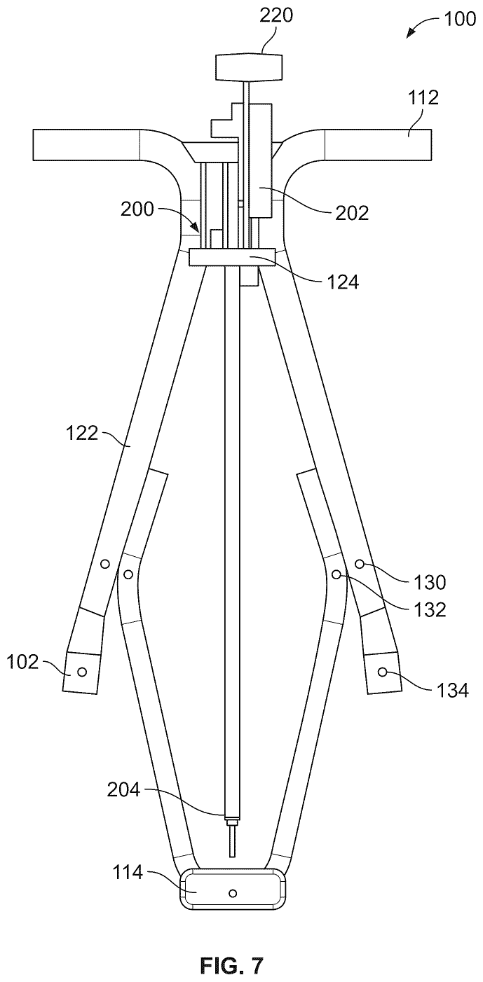

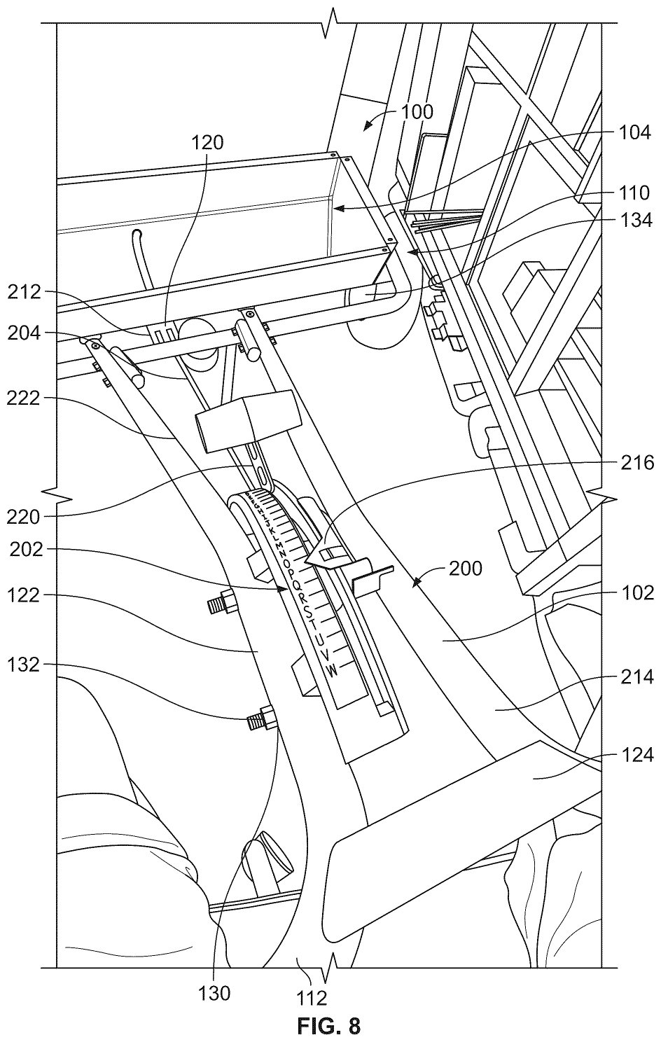

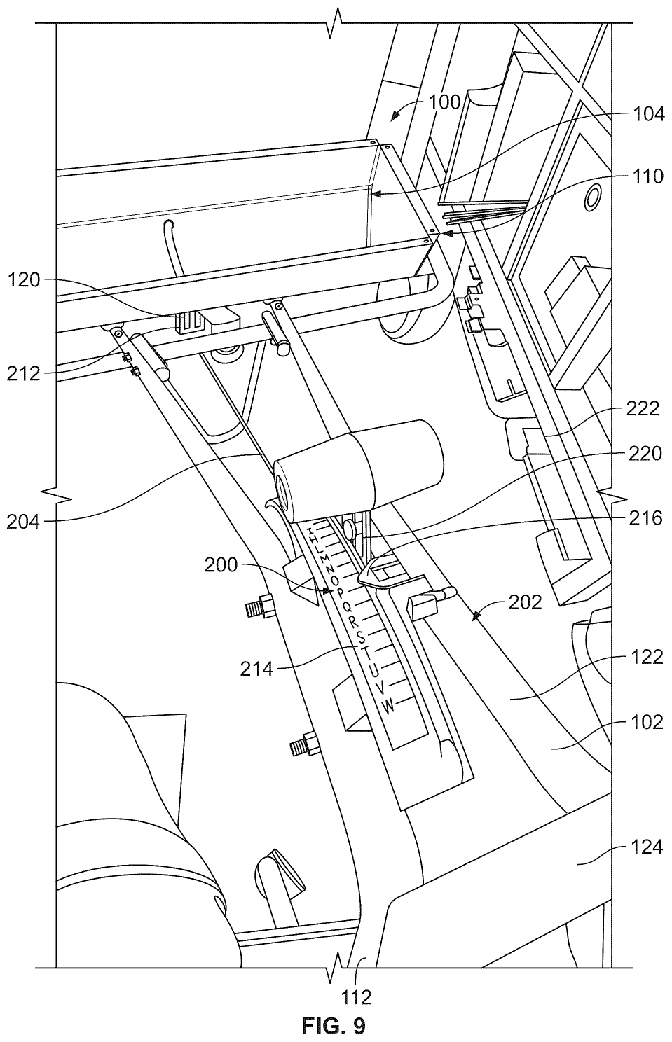

FIGS. 1-7 depict a material spreader 100 including a frame 102, and FIGS. 8 and 9 depict the material spreader 100 further including a hopper 104 and wheels 110. With reference to FIGS. 1-7, the frame 102 includes a proximal end portion that forms handles 112, and a distal end portion that forms a hopper mount 114, where the hopper 104 is fixed with the frame 102.

The frame 102 provides structure in the material spreader 100 and may support each of the hopper 104, the wheels 110, the handles, or mounts of any of the foregoing, and any other components of the material spreader 100 in their corresponding and relative positions on frame 102 during storage and use. In an embodiment, the frame 102 may generally include one or more, e.g., two, vertical bars that extend the approximate length of the frame 102. In an embodiment, the frame 102 or the lawn spreader including all components may be symmetrical. The vertical bars may provide attachment and align the hopper 104, the wheels 110, the handles 112, or mounts of any of the foregoing, and any other components of the material spreader 100 in their corresponding and relative positions on frame 102 during storage and use. For example, sections of the frame 102 may attach to or serve as the one or more handles 112, e.g., two handles, at a top side of the material spreader 100. It is noted that the handles 112 may be integrated into the frame 102 or the handles 112 may be attached to the frame 102, e.g., by a handle mount, as a separate component.

As shown in FIG. 8, in another example, sections of the frame 102 may attach to or mount the hopper 104. The hopper 104 may be positioned near or adjacent to the wheels 110, and rotatably fastened to the frame 102. The hopper 104 may be a container or bin configured to hold material (e.g., fertilizer, grass seed, lime, sand, ice melt/salt, or herbicide, etc.) to be spread by the material spreader 100 onto a surrounding surface area (e.g., lawn, garden, golf, sportsground, or other landscape areas, etc.). It is noted that the material spreader 100 may be used or adapted to any application including, but not limited to, spreading fertilizers, grass seed, lime, sand, ice melt/salt, or herbicides, etc. The hopper 104 may be open or accessible from a top side of the hopper 104 to fill and monitor the level of the material therein. The hopper 104 may define an aperture 120 at a bottom side of the hopper 104 configured to distribute the material therein onto the surrounding surface area and an angled base to direct material to the aperture as the level within the hopper 104 decreases with use. The hopper 104 may be made from any material as may be suitable or desired, including plastic or metal and may vary in size. The hopper 104 may be swappable and interchangeable with hoppers of different volume capacities and aperture sizes, shapes, materials, functions, and the like.

Likewise, the frame 102 may be made from any material as may be suitable or desired, including metals, such as steel or aluminum, or plastic and may be fixed or may be adjustable in height and/or angle. The frame 102 may include rods 122 that define an external shape of the frame 102. The frame 102 may further include one or more cross bars 124, such as horizontal bars, that may be used to reinforce the structure of the frame 102 and provide additional stability and strength. For example, the cross bars 124 may connect different parts of the frame, such as between the handles 112, below the hopper 104, between the rods 122, at or near any of the corresponding mounts, or otherwise within the frame 102. The frame 102 may further include holes 130 and complementary fasteners 132 that attach to any of the described components, including the hopper 104, the wheels 110, the handles 112, mounts of any of the foregoing, and additional components of the material spreader 100. To provide adjustment in height or angle, the frame 102 may include telescoping portions or pivot joints and corresponding holes and fasteners to lock its position.

The frame 102 also includes wheel mounts 134 that may attach to one or more of the wheels 110, e.g., two wheels, at a bottom side of the material spreader 100, below the hopper 104. The handles 112 and the wheels 110 may facilitate movement and/or directionality of the material spreader 100 as the material spreader 100 is held, pushed, pulled, or otherwise used by an operator. In an embodiment, the handles 112 and/or wheels 110 may be fixed or may be adjustable.

FIGS. 8 and 9 depict a flow rate control system 200 included in the material spreader 100. The flow rate control system 200 may include a gauge assembly 202. The gauge assembly 202 may be located at or near the handles 112 and may be coupled to a rod 204 that is a drive rod operatively connecting the gauge assembly 202 to a valve 212 included in the flow rate control system 200. In this regard, the valve 212 is fixed with the hopper 104 at a bottom of the hopper 104, where gravity feeds material from the hopper 104, through the aperture 120, and through the valve 212. The valve 212 obstructs flow of material through the aperture 120 when the valve 212 is in a closed position, and the valve 212 passes the material through the aperture 120 when the valve 212 in an opened position.

With this construction, the rod 204 may selectively control material flow from the hopper 104, through the aperture 120, distributing material held in the hopper 104 at a desired rate. For example, the rod 204 and the gauge assembly 202 may control whether the aperture 120 is fully open or closed (e.g., on or off) at the valve 212, and further control an intermediate degree to which the valve is open or closed. For example, the rod 204 and the gauge assembly 202 may increase or reduce the size of aperture 120 at the valve 212, which may increase or reduce the rate of distribution of material from the hopper 104 and which may be selected based on the size and type of material in the hopper 104 to be distributed by the material spreader 100. In an embodiment, the rod 204 may be considered a part of the frame 102.

It is noted that while embodiments herein may describe a rod control linkage to control the hopper 104, a size of the aperture 120, and spread contents held therein, other mechanical systems are also herein contemplated. For example, the material spreader 100 may include cable driven systems. For example, the gauge assembly 202 may be located at or near the handles 112 of the material spreader 100 and may be coupled to a hopper cable that generally connects the gauge assembly 202 to the hopper 104. Such a hopper cable may be attached to or coupled with one or more wheels or pulleys. In a further embodiment, the hopper cable may selectively control an aperture 120 on the bottom side of the hopper 104, which, in turn, selectively distributes material held in the hopper 104 at a rate based on the size of the aperture 120. For example, the hopper cable and the gauge assembly 202 may control whether aperture 120 is open or closed (e.g., on or off) at the valve 212. For example, the hopper cable and the gauge assembly 202 may control the size of aperture 120 which may affect the rate of distribution of material in the hopper 104 and which may be selected based on the size and type of material in the hopper 104 to be distributed by the material spreader 100. It is also noted that combined rate control mechanical systems may be utilized, including rate control systems that include one or more rods similar to the rod 204, or one or more hopper cables without departing from the scope of the present disclosure.

As shown in FIGS. 8 and 9, the flow rate control system 200 may be set within a range of material flow rate settings at the gauge assembly 202. For example, the flow rate control system 200 may have one or more, at least two, three, four, five, six, seven, eight, nine, ten, fifteen, twenty, twenty-five, etc., possible rate selections including all numbers therebetween as well as more than those stated. The range of material flow rate settings at the gauge assembly 202 may include discrete settings, or include continuous ranges of settings. For example, the flow rate control system 200 may have up to 30, 40, 50, etc., possible rate selections including all numbers therebetween. The rate selections on the gauge assembly 202 are indicated by indicia 214 that may be differentiated by letters, numbers, shapes, symbols, or the like. The variable rate selections correspond to a state of the aperture 120, including, for example, a closed position, an open position, or an intermediate size of aperture 120 at the valve 212. It is noted that the aperture 120 may be any shape as suitable or desired, including rectangular, square, polygonal, circular, ovular, irregular, or the like. It is noted that the variable size of the aperture 120 at the valve 212 may refer to width, diameter, circumference, perimeter, or the like of the valve 212 at the aperture 120.

The gauge assembly 202 includes a lever 220 operatively connected to the valve 212 through the rod 204, and pivotally fixed relative to the valve 212. As depicted, the frame 102 is fixed with the hopper 104 at an end of the frame 102 opposite the handles 112, and the lever 220 is fixed along the frame 102 at a location closer to the handle 112 as compared to the hopper 104. With this construction, an individual user operating the material spreader 100 may maneuver the frame 102 by the handles 112 while simultaneously operating the gauge assembly 202 without requiring additional help.

Pivoting the lever 220 in a first direction along the indicia 214, from a first position toward a second position, actuates the valve 212 toward the opened position through the rod 204. Pivoting the lever 220 in a second direction along the indicia 214, opposite the first direction, from the second position toward the first position, actuates the valve 212 toward the closed position through the rod 204. Pressing the lever 220 inward in the longitudinal direction, toward the indicia 214, drives the lever 220 from an extended position toward a retracted position, explained in greater detail below.

FIG. 8 depicts the lever 220 in the first position, corresponding to the valve 212 being in the closed position. FIG. 9 depicts the lever 220 in the second position, corresponding to the valve 212 being in the opened position. In this manner, pivoting the lever 220 between the first position and the second position in the first direction and the second direction along the indicia 214 respectively opens and closes the valve 212 at the aperture 120.

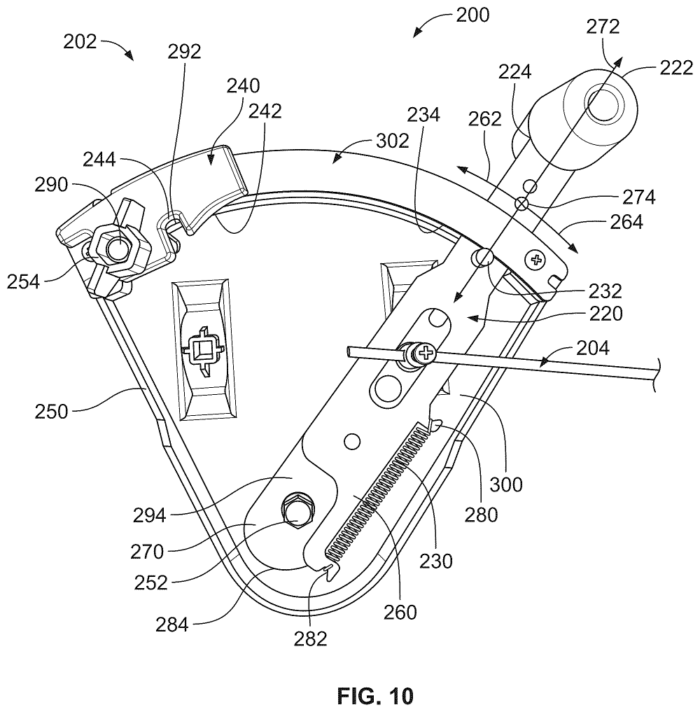

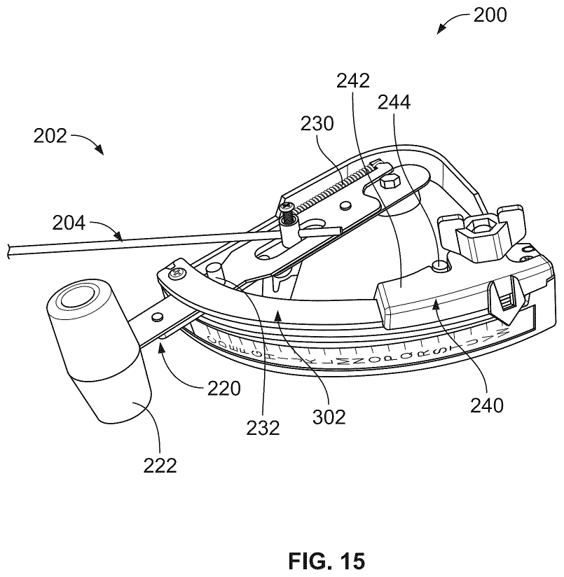

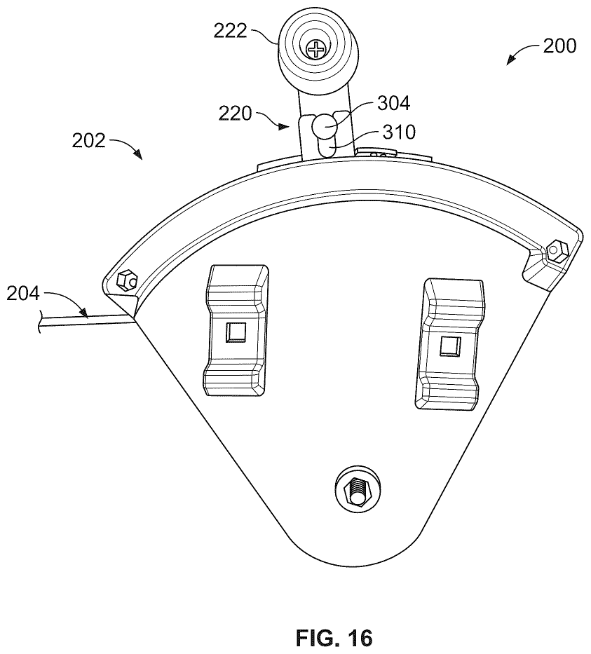

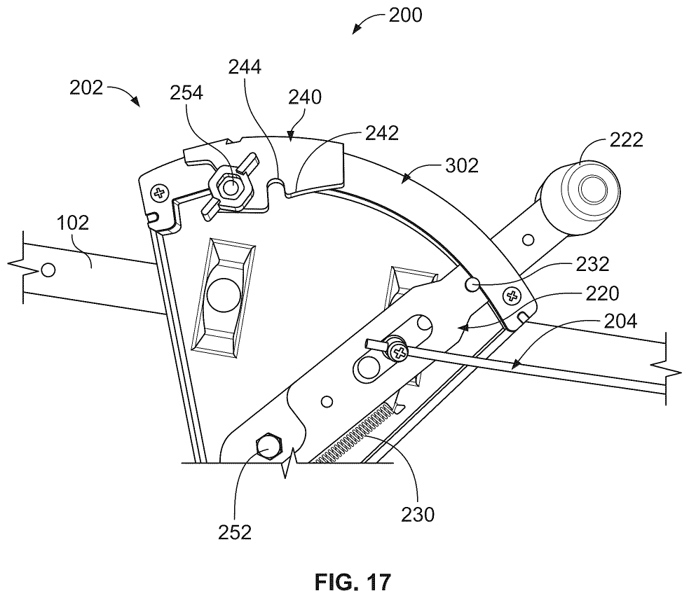

FIGS. 10-18 depict the gauge assembly 202 of the flow rate control system 200. As shown in FIG. 10, the gauge assembly 202 includes the lever 220, and the lever includes a grip 222 fixed with a distal end 224 of the lever 220. The lever 220 is biased with a spring 230 and includes a protuberance 232. The gauge assembly 202 further includes a first ramped surface 234 and a stop 240, where the stop 240 includes a second ramped surface 242 and defines a detent 244 configured to receive the protuberance 232 on the lever 220 at a predetermined location that is adjustable along the first ramped surface 234. The gauge assembly 202 includes a housing 250, and a first fastener 252 that pivotally fixes the lever 220 to the housing 250.

With reference to FIG. 10, in embodiments, the stop 240 is slidable along the first ramped surface 234 in the first direction and the second direction. The position of the stop 240 on the first ramped surface 234 may generally correspond to a desired size of the aperture 120 or opening on the underside of the hopper 104, the size of which, in turn, may correspond to an amount of material that can be released from the hopper 104 during use of the material spreader 100. The stop 240 may be set and locked in a chosen position by a second fastener 254 that is a tightening (or loosening) wingnut and screw, for example, or may be friction fit. Referring back to FIGS. 8 and 9, the stop 240 may include an indicator 216 that corresponds to the rate selection performed by the lever 220, based on the position of the stop 240 on the first ramped surface 234. The indicator 216 indicates a rate of flow or state of the valve 212 corresponding to the indicia. In an embodiment, the stop 240 may not be adjusted while the lever 220 is engaged with the stop 240.

With reference to FIG. 10, the lever 220 includes a first arm 260 that is pivotally fixed relative to the valve 212 in the first direction, indicated by arrow 262, and the second direction, indicated by arrow 264. The lever 220 also includes a second arm 270 that is slidingly fixed to the first arm 260 in a longitudinal direction, indicated by arrow 272. The first arm 260 an the second arm 270 extend from the first fastener 252, upwards and outwards from the housing 250 in the longitudinal direction, passed the indicia 214. With this construction, the lever 220 locates the grip 222 outside the housing 250, where the grip 222 is accessible to a user for operating the gauge assembly 202.

The first arm 260 is directly and pivotally fixed to the housing 250 through the first fastener 252, and the stop 240 is directly fixed to the housing 250 through the second fastener 254. The housing 250 is rigidly fixed relative to the hopper 104 and the valve 212 through the frame 102. With this construction, each of the lever 220 and the stop 240 are supported in the housing 250 and fixed relative to the hopper 104 and the valve 212 through the frame 102 and the drive rod 204. Also, the frame 102 is fixed with the hopper 104 and the housing 250, where the lever 220 is pivotally or slidingly fixed relative to the hopper 104 through the housing 250 and the frame 102.

The distal end 224 of the lever 220 if formed from a distal end of the second arm 270 extended away from the first arm 260 in the longitudinal direction of the lever 220 indicated by arrow 272, the longitudinal direction of the lever 220 being orthogonal to the first direction and the second direction. The grip 222 is fixed with the distal end 224 formed form the second arm 270, where the grip 222 overlaps the first arm 260 and the second arm 270 in the longitudinal direction, and extends beyond the lever 220 in the first direction, the second direction, or a lateral direction indicated by arrow 274, the lateral direction being orthogonal to the longitudinal direction, the first direction, and the second direction.

The spring 230 biases the second arm 270 away from the first arm 260 in the longitudinal direction, toward the extended position. More specifically, the spring 230 elastically biases the second arm 270 away from the first arm 260 in the retracted position, toward the extended position. In this regard, the first arm 260 includes a first spring seat 280, and the second arm 270 includes a second spring seat 282, where the first spring seat 280 and the second spring seat 282 are fixed with opposite ends of the spring 230. While, as depicted, the spring 230 is hooked onto the first spring seat 280 and the second spring seat 282, where the spring 230 is in tension and pulling the second arm 270 away from the first arm 260 in the longitudinal direction, toward the extended position, the lever 220 may additionally or alternatively include a compression spring seated between the first arm 260 and the second arm 270, where the compression spring presses the second arm 270 away from the first arm 260 and toward the extended position in the longitudinal direction without departing from the scope of the present disclosure. When the lever 220 is in the extended position, where the second arm 270 is elastically offset from the first arm 260 in the longitudinal direction, a user may press the lever 220 inward in the longitudinal direction, toward the housing 250, at the grip 222, compressing the first arm 260 and the second arm 270 in the longitudinal direction toward the retracted position.

With continued reference to FIG. 10, the second arm 270 includes the protuberance 232 that is a pin extended from the lever 220 in the lateral direction. The protuberance 232 is rigidly fixed with he second arm 270, where the protuberance 232 travels with the lever 220 in the first direction and the second direction as the lever 220 pivots relative to the hopper 104, and travels with the second arm 270 in the longitudinal direction between the extended position and the retracted position.

In a non-limiting example shown in FIGS. 8 and 9, rate selections along the indicia 214 closer to the handles 112 may correspond to a larger size of the aperture 120 or opening on the underside of the hopper 104 while rate selections along the indicia 214 closer toward the hopper 104 may correspond to a smaller size of the aperture 120 or opening on the underside of the hopper 104. In an embodiment, movement of the stop 240 may not open or close the aperture 120 or change the size of the aperture 120 directly. In another embodiment, the stop 240 may serve as a stop point for the lever 220, which actuates the size and on/off status of the aperture 120 through the rod 204. In various embodiments, the rod 204 may be provided as a singular rod or as one or more separate attachable components that operatively connect the gauge assembly 202 and the valve 212, either embodiments of which provide actuation and adjustment of the aperture 120 at the valve 212.

While, as depicted, the lever 220 is pivotally fixed directly with the housing 250, and pivotally fixed relative to the hopper 104 and the valve 212 through the frame 102 and the housing 250, the lever 220 may be slidingly fixed with the housing 250 without departing from the scope of the present disclosure. In such an embodiment of the gauge assembly 202, the lever 220 may be fixed to the housing 250 through at least one linear track that guides the lever 220 between the first position and the second position in a first linear direction and a second linear direction. In such an embodiment, the first direction and the second direction of the linear are linear and follow a translation path of the lever 220 along the tracks, rather than curved and following the lever 220 along a rotational path relative to the housing 250, the frame 102, the hopper 104, and the valve 212.

The position of the lever 220 on the first ramped surface 234 may correspond to a desired size of the aperture 120 or opening on the underside of the hopper 104. Further the size of the aperture 120 or opening may correspond to an amount of material released from the hopper 104 during use of the material spreader 100. In this manner, the position of the lever 220 may correspond to a desired rate of material flow from the hopper 104.

With continued reference to FIG. 10, the lever 220 is biased upward in the longitudinal direction, from the first fastener 252 toward the extended position by the spring 230, where the second arm 270 presses the protuberance 232 against the first ramped surface 234 and the second ramped surface 242 in the longitudinal direction. As such, the protuberance 232 is biased against the first ramped surface 234, where the protuberance 232 interacts with and moves along first ramped surface 234. In an embodiment, the spring 230 may actuate locking and unlocking mechanisms of the lever 220 along first ramped surface 234. For example, lever 220 may be set and locked in a chosen position by interaction with the stop 240.

As such, the housing 250 defines the first ramped surface 234, and the protuberance 232 is biased against in the first ramped surface 234 in the extended position, where first ramped surface 234 abuts the protuberance 232 in the longitudinal direction the first ramped surface 234 guides the protuberance 232 in the first direction and the second direction. While, as depicted, the protuberance 232 is a pin that is rigidly fixed with the second arm 270 and slides along the first ramped surface 234 and the second ramped surface 242 in the first direction and the second direction, the protuberance 232 may additionally or alternatively include a roller that rolls along the first ramped surface 234 and the second ramped surface 242 in the first direction and the second direction without departing from the scope of the present disclosure.

The stop 240 defines the second ramped surface 242, which extends across and inward from the first ramped surface 234, toward the first arm 260 in the longitudinal direction. With this construction, the second ramp surface 242 extends continuously and smoothly downward from the first ramped surface 234 along the first direction, where the second ramped surface 242 guides the second arm 270 to the retracted position through the protuberance 232. As such, the second ramped surface 242 drives the second arm 270 through the protuberance 232, toward the retracted position when the lever 220 travels along the stop 240 in the first direction. more specifically, the stop 240 is fixed with the housing 250 and defines the second ramped surface 242 extended continuously inward from the first ramped surface 234 in the longitudinal direction, where the second ramped surface 242 abuts the protuberance 232 in the longitudinal direction such that the second ramped surface 242 presses the second arm 270 toward the retracted position through the protuberance 232 when the lever 220 travels in the first direction.

The stop 240 defines the detent 244 as the predetermined location, where the detent 244 catches the protuberance 232 traveling in the first direction. the stop 240 also defines the second ramped surface 242 that extends from the first ramped surface 234, toward the detent 244 in the first direction, and guides the protuberance 232 toward the detent 244 when the lever 220 moves in the first direction. The predetermined location defined at the detent 244 sets a corresponding maximum open state of the valve 212 associated with a forward-most position of the lever 220 along the indicia 214 in the first direction.

With continued reference to FIG. 10, a position of the stop 240, including the detent 244 setting the predetermined location, along the indicia 214 in the first direction or the second direction is adjustable by manually unlocking the stop 240 at the second fastener 254, moving the stop 240 along the first ramped surface 234, and locking the stop 240 at the second fastener 254. In this manner, the second fastener 254 is a manual locking mechanism that fixes the stop 240 to the housing 250 and sets the predetermined location along the first ramped surface 234, where the stop 240, including the detent 244 defining the predetermined location, is moveable along the first ramped surface 234 when the manual locking mechanism is unlocked, and the stop 240 is rigidly fixed along the first ramped surface 234 when the manual locking mechanism is locked.

The rod 204 is pivotally fixed with the first arm 260 and translates a linear component of travel of the first arm 260 to the valve 212. The rod 204 operatively connects the lever 220 and the valve 212, where the rod 204 drives the valve 212 between the opened position and the closed position by transmitting linear mechanical power between the lever 220 and the valve 212.

With continued reference to FIG. 10, the rod 204 is fixed with the first arm 260 at a location along the lever 220 in the longitudinal direction that leverages torque at the gauge assembly 202 as a hand-operated component for reliably driving the valve 212, while requiring sufficient movement of the lever 220 along the indicia 214 that facilitates a user reliably, manually selecting a corresponding valve state 212 within a given range between the opened state and the closed state. In this regard, the first arm 260 forms a first lever end 284 that is a proximal end opposite the distal end 224 of the lever 220 in the longitudinal direction, the distal end 224 of the lever 220 being formed from the second arm 270 as a second lever end opposite the first lever end 284 in the longitudinal direction. Also, the rod 204 is pivotally fixed with the first arm 260 at a location closer to a middle point between the proximal end that is the first lever end 284, and the second lever end that is the distal end 224 in the longitudinal direction, as compared to the first lever end 284 and the second lever end in the longitudinal direction.

As the rod 204 is pivotally fixed with the first arm 260 a fixed distance from the first fastener 252 in the longitudinal direction, the second arm 270 may travel between the extended position and the retracted position independently of the lever 220 moving between the first position and the second position along the first ramped surface 234. With this construction, the first arm 260 and the valve 212 maintain a relatively stable position of the rod 204 in the longitudinal direction.

With continued reference to FIG. 10, the stop 240 defines the detent 244 including a first stop surface 290 and a second stop surface 292 opposite the first stop surface 290 in the first direction and the second direction. The first stop surface 290 and the second stop surface 292 extend straight in or along the longitudinal direction, defining a slot in the detent 244. With this construction, the detent 244 catches the protuberance 232 at the predetermined location between the first stop surface 290 and the second stop surface 292 in the first direction and the second direction. The first stop surface 290 is longer than the second stop surface 292 in or along the longitudinal direction, such that when the protuberance 232 is caught in the detent 244, the first stop surface 290 obstructs the protuberance 232 and by extension the lever 220 as a whole from traveling in the first direction when the lever 220 is in the extended position and the retracted position. More specifically, the first stop surface 290 extends along the longitudinal direction at positions corresponding to the extended position and the retracted position of the protuberance 232 in the first direction, while the second stop surface 292 extends along the longitudinal direction at a position corresponding to the extended position of the protuberance 232 in the second direction, and terminates before the retracted position of the protuberance 232 in the second direction.

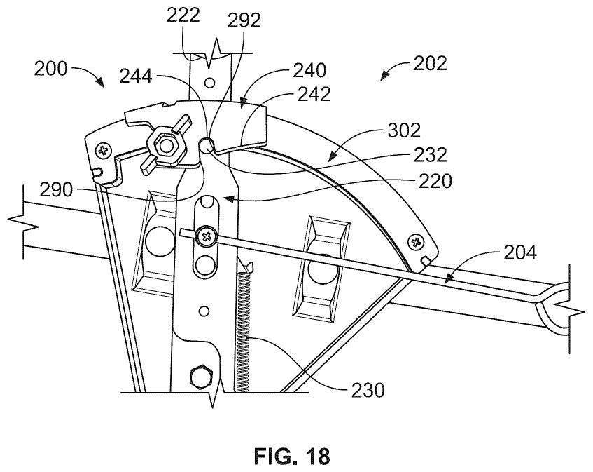

FIG. 18 depicts the lever 220 in the second position, where the protuberance 232 is retained in the detent 244. As shown in FIG. 18, the second stop surface 292 obstructs the protuberance 232 from traveling in the second direction when the lever 220 is in the extended position, and the protuberance 232 passes the second stop surface 292 in the second direction when the lever 220 is in the retracted position. In this manner, the stop 240 obstructs the lever 220 from traveling passed the predetermined location in the second direction when the lever 220 is in the extended position, and the lever 220 passes the predetermined location in the second direction when the lever 220 is in the retracted position.

With this construction, the stop 240 catches the lever 220 traveling in the first direction from the first position when the lever 220 is in the extended position and reaches the second position at the predetermined location defined by the detent 244. Also, the stop 240 retains the lever 220 at the second position when the lever 220 is in the extended position, and obstructs the lever 220 from traveling farther than the second position, passed the predetermined location, in the first direction in either the extended position or the retracted position. Also, the stop 240 releases the lever 220 from the predetermined location in the second direction when the lever 220 is in the retracted position.

As such, a user operating the material spreader 100 at the handles 112 with a first hand may simultaneously actuate the gauge assembly 202 with a second hand, driving the valve 212 between the opened position and the closed position. More specifically, such a user may operate the flow rate control system 200 by pulling the lever 220 at the grip 222 in the first direction from the first position to the second position, driving the valve 212 to the opened position, where the stop 240 catches and locks the lever 220 at the predetermined location. Such a user may further operate the flow rate control system 200 with a single hand by pressing the lever 220 inward in the longitudinal direction at the grip 222, compressing the lever 220 to the retracted position, unlocking the lever 220 from the stop 240 in the second direction, and pushing the lever 220 toward the second position shown in FIG. 10, driving the valve 212 to the closed position. In an embodiment, such a user further unlocks the stop 240 from the housing 250, moves the stop 240 along the first ramped surface 234, then locks the stop 240 with the housing 250, setting a predetermined maximum opened state of the valve 212 associated with the predetermined location of the second position defined by the detent 244.

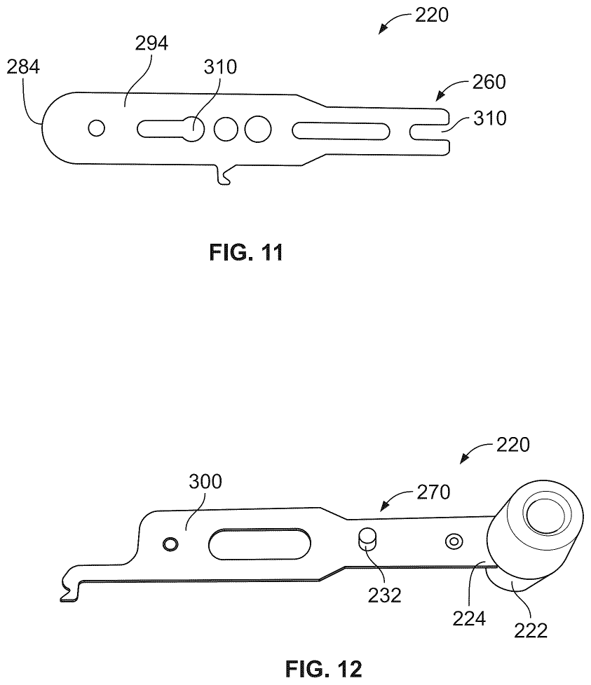

As shown in FIGS. 11 and 12, the lever 220 includes a first plate 294 and a second plate 300. The first plate 294 and the second plate 300 may be flat and configured to engage and align with one another to form the lever 220. In an embodiment, the first plate 294 is a hinged lever pivotally fixed on or otherwise attached to the gauge assembly 202. In an embodiment, the second plate 300 is a sliding lever that may not directly attach to the gauge assembly 202 body, but may move relative the gauge assembly 202 body by a spring connection with the first plate 294.

More specifically, the first arm 260 includes the first plate 294, the second arm 270 includes the second plate 300, the first plate 294 and the second plate 300 are each planar along the longitudinal direction, the first direction, and the second direction, and the first plate 294 and the second plate 300 are mated with each other in a sliding relationship in the longitudinal direction. The protuberance 232 is a pin that extends straight from a planar surface of the first arm 260 in the lateral direction orthogonal to the longitudinal direction, the first direction, and the second direction, and is rounded about the lateral direction at a contact area that slides along the first ramped surface 234 and the second ramped surface 242 when the lever 220 travels in the first direction.

Referring back to FIG. 10, the housing 250 includes a third plate 302 that is planar along the longitudinal direction, the first direction, and the second direction, and forms the first ramped surface 234. The first plate 294, the second plate 300, and the third plate 302 are formed from metal. Each of the first plate 294, the second plate 300, and the third plate 302 are formed from metal, and elongated in the first direction and the second direction. With this construction, the lever 220 occupies a relatively small space in the lateral direction, while maintaining sufficient structural integrity that transfers actuating force from the gauge assembly 202 to the valve 212.

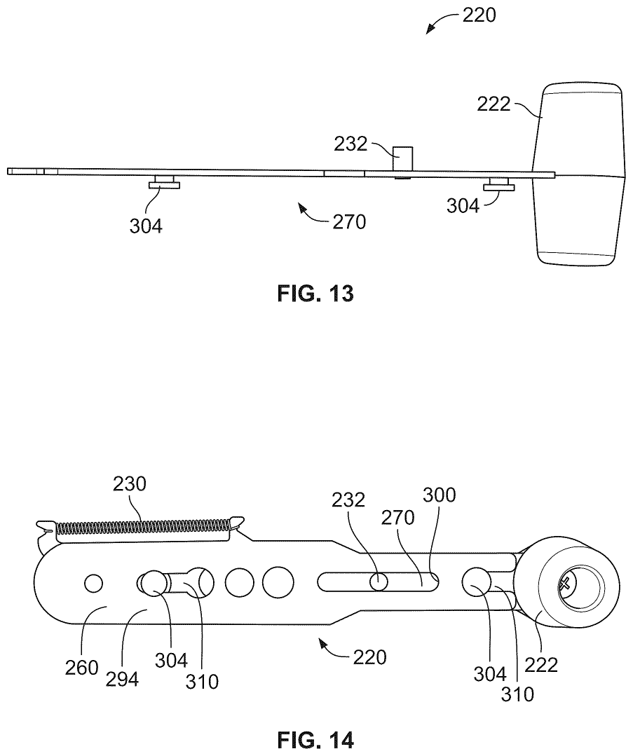

As shown in FIG. 13, the second plate 300 may include one or more protrusions 304, which correspond to one or more slots 310 on the first plate 294. As shown in FIG. 14, the one or more slots 310 on the first plate 294 may be configured to receive the corresponding protrusions 304 on the second plate 300 and provide channels for the protrusions 304 to move therethrough in the longitudinal direction by relative force exerted on spring 230. It is noted that opposite configurations including protrusions on the first plate 294 and slots on the second plate 300 may also be used. In an embodiment, the second plate 300 may include the grip 222 and the protuberance 232. It is noted that a fastener may also be used to connect through openings on each the first plate 294 and the second plate 300 and provide attachment to the rod 204.

Referring back to FIG. 10, the second plate 300 and the first plate 294 have an elastically deformable connection therebetween via the spring 230, where the second plate 300 may slide on the first plate 294 of the lever 220 through compression and extension of the spring 230 and forces applied to the lever 220 by the user or varying surface levels configured to engage with protuberance 232 such as the first ramped surface 234, the second ramped surface 242, and the detent 244. The spring 230 may bias the lever 220 outwards or bias the protuberance 232 against the first ramped surface 234. In an example, as the grip 222 is pushed or pressed by a user, or another force is applied to the spring 230, e.g., by interaction of the protuberance 232 on the second ramped surface 242, the protrusions 304 may move within the slots 310 to compress spring 230. In an example, as the grip 222 is released, protrusions 304 may move within the slots 310 by expansion of the spring 230.

The lever 220 may be moveable forwards and backwards in the first direction and the second direction with the protuberance 232 against the first ramped surface 234 without additional force or compression of the spring 230. When the lever 220 is moved toward the stop 240, the protuberance 232 may engage the second ramped surface 242, causing the spring 230 to compress, for example, by movement of the protrusions 304 within the slots 310 where the second ramped surface 242 protrudes closer to spring than first ramped surface 234. When the lever 220 is moved against the stop 240, the protuberance 232 may enter the detent 244 (e.g., where the detent 244 is recessed further away from spring than second ramped surface 242), causing the spring 230 to expand and the protuberance 232 to lock in the detent 244. To unlock the protuberance 232 from this position, force on the grip 222 may be used to manually compress the spring 230 by a user (e.g., by movement of the protrusions 304 within the slots 310) to release the protuberance 232 from the detent 244 back onto the second ramped surface 242 and the first ramped surface 234. As described herein, movement of the lever 220 to the stop 240 (e.g., moving the protuberance 232 into the detent 244) may open the aperture 120 and adjust the size of the aperture 120 at the valve 212 as may be chosen or desired for the material spreader 100.

As described herein, movement of the lever 220 from the stop 240 (e.g., moving the protuberance 232 out of the detent 244) may automatically close aperture 120 by an automatic spring closure. For example, the rod 204 may be biased by a second spring (not shown). In an embodiment, the second spring may pull the lever 220 and cause clockwise rotation at the gauge assembly 202, actuating the valve 212 toward the closed position. In this manner, the flow rate control system 200 may be biased with the valve 212 in the closed or off position. The force of the second spring may be overcome by application of manual force to the lever 220 which moves the lever 220 against and along the first ramped surface 234 and toward the stop 240. In an embodiment, the second spring may be located in the area of the hopper 104 and coupled to the rod 204 providing a pull to shut force on the gauge assembly 202 and the lever 220, and causing the rod 204 to rotate in a clockwise direction, for example. In an embodiment, the pull to shut force from the second spring may be constant on the rod 204 when the gauge assembly 202 is set in any position of rate control selections by the stop 240. The detent 244 of the stop 240 may hold and lock the protuberance 232 and the lever 220 in a desired open position determined by the position of the stop 240 on the first ramped surface 234 of the gauge assembly 202. To unlock the protuberance 232 from this desired open position (relative the aperture 120), force on the grip 222 may be used to manually compress the spring 230 by a user (e.g., by movement of the protrusions 304 within slots 310) to release the protuberance 232 from the detent 244 back onto the second ramped surface 242 and the first ramped surface 234. Once the protuberance 232 is released from the detent 244, second spring may automatically and immediately pull the lever 220 down the second ramped surface 242 and the first ramped surface 234 to its closed position, which in turn closes the aperture 120. In an embodiment, no other force is needed for lever 220 to return to this closed position once the protuberance 232 is moved from the detent 244.

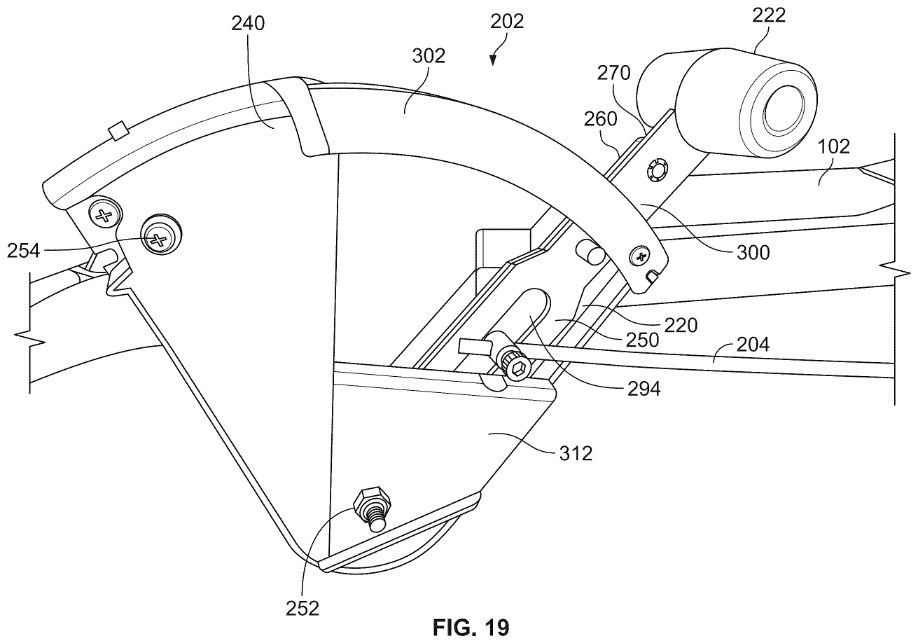

As shown in FIG. 19, the housing 250 includes paneling 312 that supports the lever 220, the stop 240, and the third plate 302 on the frame 102. The paneling 312 at least partially covers the first arm 260 and the second arm 270 in the lateral direction. The rod 204 extends from inside the housing 250 toward the valve 212, and overlaps the paneling 312 in the lateral direction and the longitudinal direction. As such, the paneling 312 shields components of the gauge assembly 202, including the first fastener 252, the lever 220, the second fastener 254, and the stop 240, from direct contact with dirt or debris during operation of the material spreader 100.

The paneling 312 may be formed from plastic, while the first plate 294, the second plate 300, and the third plate 302 are formed from metal. With this construction, the gauge assembly 202 provides structural rigidity to transfer forces from the lever 220 to the rod 204, while also maintaining a relatively light overall weight and reducing material cost. The combination of metal plates with plastic paneling balances durability with ease of handling and supports efficient manufacturing.

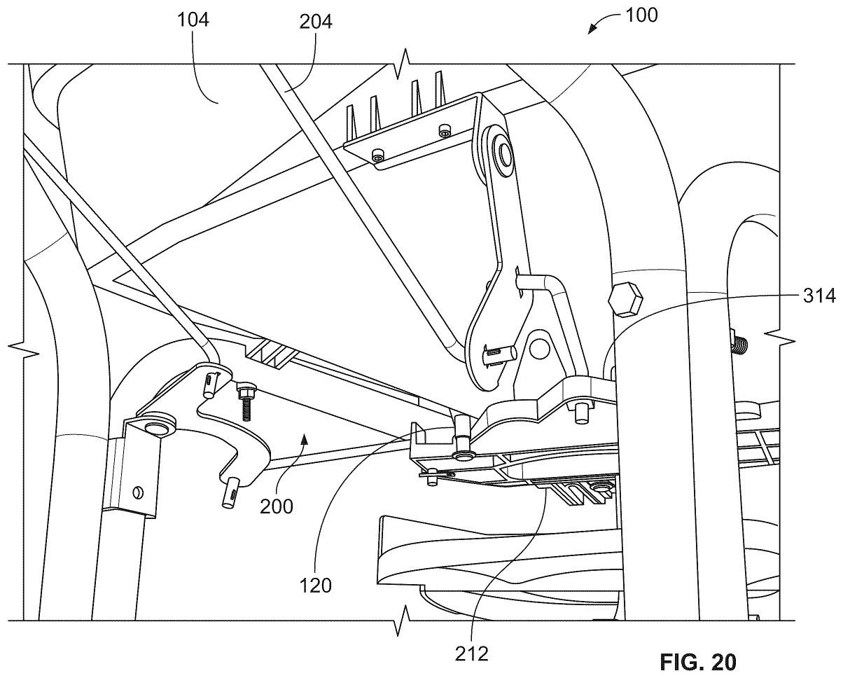

As shown in FIG. 20, the valve 212 includes a pivot bracket 314 directly mounted at the aperture 120 of the hopper 104. The pivot bracket 314 rotates between a closed position obstructing material flow and an opened position passing material through the aperture 120. The rod 204 attaches to the pivot bracket 314 and transfers linear movement from the gauge assembly 202 into pivoting movement at the valve 212. In this manner, the rod 204 translates directional travel of the lever 220 in the first direction and the second direction into actuation of the pivot bracket 314. In alternative embodiments, the valve 212 may additionally or alternatively include a slide gate valve, a knife gate valve, or a plunger valve, each of which opens and closes in response to linear actuation of the rod 204 to pass or obstruct material through the aperture 120. In such embodiments, the rod 204 drives the valve 212 with linear inputs derived from the first direction or the second direction of the lever 220 at the gauge assembly 202. As such, while in the depicted embodiment the valve 212 includes the pivot bracket 314, the valve 212 may additionally or alternatively include a knife gate valve, a plunger valve, or another linearly driven mechanical valve that passes material from the hopper 104 through the aperture 120 without departing from the scope of the present disclosure.

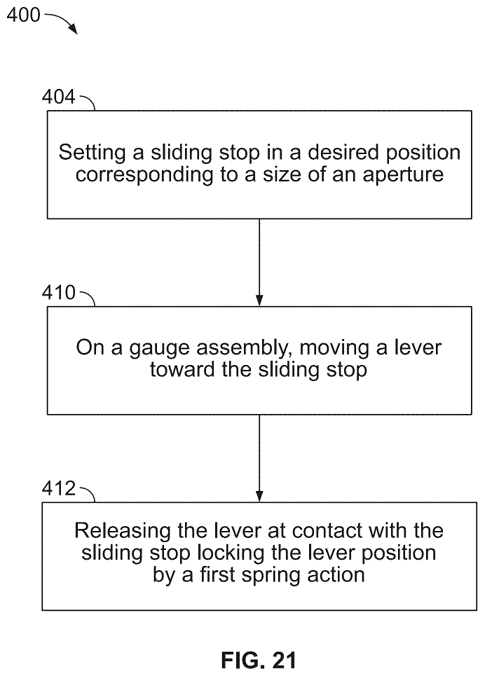

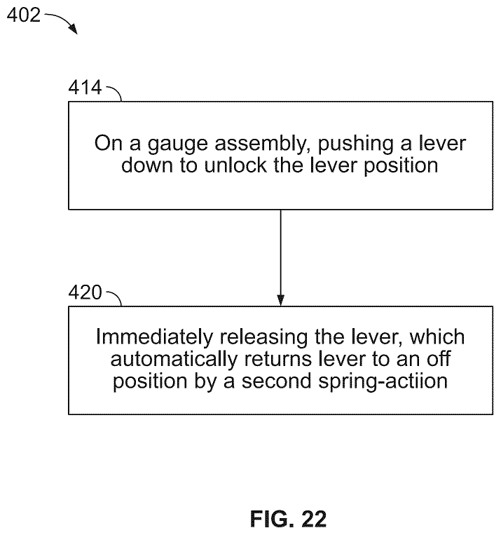

FIGS. 21 and 22 respectively depict a first method 400 of opening the valve 212, and a second method 402 of closing the valve 212. For example, a first step 404 of the first method 400 may include setting the stop 240 in a desired position corresponding to a size of the aperture 120. For example, a second step 410 of the first method 400 may include, on the gauge assembly 202, moving the lever 220 toward the stop 240. For example, a third step 412 of the first method 400 may include releasing the lever 220 from contact with the stop 240 locking the lever 220 by the spring 230. The first method 400 may be used to open and set the aperture 120 size.

The second method 402 may be used to automatically close the aperture 120 once the lever 220 is unlocked from the stop 240. For example, a first step 414 of the second method 402 may include, on the gauge assembly 202, pushing the lever 220 down to unlock the lever 220 position against the spring 230. For example, a second step 420 of the second method 402 may include immediately releasing the lever 220, which automatically returns the lever 220, the valve 212, and the aperture 120 to an off position by the second spring-action. It is noted that other steps and methods, including order of steps and combination of steps, are also herein contemplated.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

Although the embodiments of the present teachings have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof.

1. A material spreader, comprising:
a hopper that defines an aperture;
a valve fixed with the hopper, wherein the valve obstructs flow of a material through the aperture in a closed position, and passes the material through the aperture in an opened position;
a lever operatively connected to the valve, and pivotally or slidingly fixed relative to the valve, wherein pivoting or sliding the lever in a first direction actuates the valve toward the opened position, pivoting or sliding the lever in a second direction actuates the valve toward the closed position, and pressing the lever inward in a longitudinal direction drives the lever from an extended position toward a retracted position, the longitudinal direction being orthogonal to the first direction and the second direction; and
a stop that obstructs the lever from traveling passed a predetermined location in the second direction when the lever is in the extended position, wherein the lever passes the predetermined location in the second direction when the lever is in the retracted position.

2. The material spreader of claim 1, wherein the stop:
catches the lever traveling in the first direction, at the predetermined location, when the lever is in the extended position;
releases the lever from the predetermined location in the second direction when the lever is in the retracted position; and
obstructs the lever from traveling passed the predetermined location in the first direction when the lever is in the extended position and the retracted position.

3. The material spreader of claim 1, further comprising a protuberance extended from the lever in a lateral direction orthogonal to the longitudinal direction, the first direction, and the second direction, wherein the protuberance travels with the lever in the first direction and the second direction as the lever pivots or slides relative to the valve, and travels with the lever in the longitudinal direction between the extended position and the retracted position,
the stop defines a detent that catches the protuberance at the predetermined location between a first stop surface and a second stop surface in the first direction and the second direction, where the first stop surface obstructs the protuberance from traveling in the first direction when the lever is in the extended position and the retracted position, the second stop surface obstructs the protuberance from traveling in the second direction when the lever is in the extended position, and the protuberance passes the second stop surface in the second direction when the lever is in the retracted position, the first stop surface being longer than the second stop surface in the longitudinal direction.

4. The material spreader of claim 1, wherein the lever includes a first arm that is pivotally or slidingly fixed relative to the valve in the first direction and the second direction, and a second arm that is slidingly fixed to the first arm in the longitudinal direction.

5. The material spreader of claim 4, wherein the lever includes a grip fixed with a distal end of the second arm, where the grip overlaps the first arm and the second arm in the longitudinal direction, and extends beyond the lever in the first direction, the second direction, or a lateral direction orthogonal to the longitudinal direction, the first direction, and the second direction.

6. The material spreader of claim 5, wherein the lever includes a spring that biases the second arm away from the first arm in the longitudinal direction, toward the extended position.

7. The material spreader of claim 6, further comprising a housing fixed relative to the valve, wherein the first arm is pivotally or slidingly fixed to the housing,
the second arm includes a protuberance extended from the lever in a lateral direction orthogonal to the longitudinal direction, the first direction, and the second direction, wherein the protuberance travels with the lever in the first direction and the second direction as the lever pivots or slides relative to the hopper, and travels with the second arm in the longitudinal direction between the extended position and the retracted position, and
the housing defines a first ramped surface, and the protuberance is biased against in the first ramped surface in the extended position, where the first ramped surface guides the protuberance in the first direction and the second direction.

8. The material spreader of claim 7, wherein the stop defines a second ramped surface that extends inward from the first ramped surface, toward the first arm in the longitudinal direction, such that the second ramped surface drives the second arm through the protuberance, toward the retracted position when the lever travels along the stop in the first direction.

9. The material spreader of claim 8, wherein the stop defines a detent as the predetermined location, where the detent catches the protuberance traveling in the first direction, and
the second ramped surface extends from the first ramped surface, toward the detent in the first direction, and guides the protuberance toward the detent when the lever moves in the first direction.

10. The material spreader of claim 9, further comprising a manual locking mechanism that fixes the stop along the first ramped surface, wherein the stop, including the detent defining the predetermined location, is moveable along the first ramped surface when the manual locking mechanism is unlocked, and the stop is fixed along the first ramped surface when the manual locking mechanism is locked.

11. The material spreader of claim 1, further comprising a rod operatively connecting the lever and the valve, wherein the lever includes a first arm pivotally or slidingly fixed relative to the valve in the first direction and the second direction, the lever includes a second arm that is slidingly fixed with the first arm in the longitudinal direction, and the rod is fixed with the first arm and translates a linear component of travel of the first arm to the valve.

12. The material spreader of claim 11, wherein first arm is pivotally fixed relative to the hopper in the first direction and the second direction,
the first arm forms a first lever end, the second arm forms a second lever end opposite the first lever end in the longitudinal direction, and
the rod is pivotally fixed with the first arm at a location closer to a middle point between the first lever end and the second lever end in the longitudinal direction, as compared to the first lever end and the second lever end in the longitudinal direction.

13. The material spreader of claim 11, further comprising:
a housing, wherein the first arm is directly fixed to the housing through a first fastener, and the stop is directly fixed to the housing through a second fastener;
a frame fixed with the hopper and the housing, wherein the lever is pivotally or slidingly fixed relative to the hopper through the housing and the frame.

14. The material spreader of claim 13, wherein the frame includes a handle, the frame is fixed with the hopper at an end of the frame opposite the handle, and the lever is fixed along the frame at a location closer to the handle as compared to the hopper.

15. A flow rate control system, comprising:
a valve that obstructs flow of a material in a closed position, and passes the material in an opened position;
a lever operatively connected to the valve, and pivotally or slidingly fixed relative to the valve, wherein pivoting or sliding the lever in a first direction actuates the valve toward the opened position, pivoting or sliding the lever in a second direction actuates the valve toward the closed position, and pressing the lever inward in a longitudinal direction drives the lever from an extended position toward a retracted position, the longitudinal direction being orthogonal to the first direction and the second direction; and
a stop that obstructs the lever from traveling passed a predetermined location in the second direction when the lever is in the extended position, wherein the lever passes the predetermined location in the second direction when the lever is in the retracted position.

16. The system of claim 15, further comprising a housing fixed relative to the valve,
wherein the lever includes a first arm that is pivotally fixed to the housing, and includes a second arm that is slidingly fixed to the first arm in the longitudinal direction,
the second arm is elastically biased away from the first arm in the longitudinal direction, toward the extended position, and the lever includes a protuberance that is rigidly fixed with the second arm, such that the protuberance travels with the second arm in the longitudinal direction between the extended position and the retracted position, and travels with the second arm in the first direction and the second direction,
the housing defines a first ramped surface that abuts the protuberance in the longitudinal direction, and guides the lever along first direction and the second direction.

17. The system of claim 16, wherein the stop is fixed with the housing, and defines a second ramped surface that extends continuously inward from the first ramped surface in the longitudinal direction, and the second ramped surface abuts the protuberance in the longitudinal direction such that the second ramped surface presses the second arm toward the retracted position through the protuberance when the lever travels in the first direction.

18. The system of claim 17, wherein the first arm includes a first plate, the second arm includes a second plate, the first plate and the second plate are each planar along the longitudinal direction, the first direction, and the second direction, and the first plate and the second plate are mated with each other in a sliding relationship in the longitudinal direction,
the protuberance is a pin that extends straight from a planar surface of the first arm in a lateral direction orthogonal to the longitudinal direction, the first direction, and the second direction, and is rounded about the lateral direction at a contact area that slides along the first ramped surface and the second ramped surface when the lever travels in the first direction.

19. The system of claim 18, wherein the housing includes a third plate that is planar along the longitudinal direction, the first direction, and the second direction,
the third plate forms the first ramped surface,
the first plate, the second plate, and the third plate are formed from metal.

20. The system of claim 16, further comprising a rod operatively connecting the lever and the valve, wherein the lever defines a first lever end, and a second lever end opposite the first lever end in the longitudinal direction,
the rod is pivotally fixed with the first arm at a location closer to a middle point between the first lever end and the second lever end in the longitudinal direction, as compared to the first lever end and the second lever end in the longitudinal direction,
the housing includes paneling that at least partially covers the first arm and the second arm in a lateral direction, and
the rod extends from inside the housing toward the valve, and overlaps the paneling in the lateral direction and the longitudinal direction.
